(19) United States
(12) Patent Application Publication
(10) Pub. No.: US 2013/0215464 A1
(43) Pub. Date: Aug. 22, 2013

(54) IMAGE FORMING APPARATUS, SYSTEM, AND METHOD

(71) Applicants: Naohiko KUBO, Kanagawa (JP); Takayuki INOUE, Kanagawa (JP); Kohji YAMAMOTO, Kanagawa (JP); Yuka SAITO, Tokyo (JP); Tomoyuki TAKAHIRA, Kanagawa (JP)

(72) Inventors: Naohiko KUBO, Kanagawa (JP); Takayuki INOUE, Kanagawa (JP); Kohji YAMAMOTO, Kanagawa (JP); Yuka SAITO, Tokyo (JP); Tomoyuki TAKAHIRA, Kanagawa (JP)

(21) Appl. No.: 13/761,223

(22) Filed: Feb. 7, 2013

(30) Foreign Application Priority Data
Feb. 20, 2012 (JP) 2012-033991

(51) Int. Cl. G06K 15/00

(52) U.S. Cl. CPC G06K 15/40
USPC 358/1.15

(57) ABSTRACT

In an image forming system, after receiving print data, print setting data, and a command to display a preview from an information processing apparatus, an image drawing unit in an image forming apparatus generates a preview image that reflects the print setting data from the print data and send it to the information processing apparatus. After receiving the print data, the print setting data, and the command to start printing from the information processing apparatus, the image drawing unit generates drawing data that reflects the print setting data from the print data, and an engine unit prints out an image on paper.

### CROSS-REFERENCE TO RELATED APPLICATION

This patent application is based on and claims priority pursuant to 35 U.S.C. §119 to Japanese Patent Application No. 2012-033991, filed on Feb. 20, 2012 in the Japan Patent Office, the entire disclosure of which is hereby incorporated by reference herein.

### BACKGROUND

1. Field

The present invention relates to an image forming apparatus, system, and method, and more particularly to an image forming apparatus that facilitates providing a preview image that approximates an actual printing result.

2. Background Art

With the development of networks, image forming apparatuses such as printers, copiers, and multi functional peripherals (MFPs) have come to be integrated into networks such as Local Area Networks (LANs). After receiving image data and print setting data from information processing apparatuses such as a computer connected to the network, the image forming apparatuses print out an image on a recording medium such as paper (hereinafter simply “paper”) based on the image data and the print setting data.

Users who request printing often wish to know what the final printing result will look like before actually printing out. Also, knowing the printing result beforehand helps save resources by preventing wasteful print.

Conventionally, a technology of storing image data in a data storage device, printing only one copy as a trial (in case of printing multiple copies), and after checking for doneness of the printed copy, if the print settings are modified, printing out the image data stored in the data storage device for specified number of copies based on the modified print settings has been proposed (e.g., JP-2002-127570-A.)

However, in the technology described in JP-2002-127570-A, it is necessary to print out at least one copy as a trial since printing is executed based on the modified print settings in case print settings are modified after checking one copy printed out as a trial. Therefore, if it is necessary to modify print settings, that leads to wasting of resources such as paper and toner for printing out as a trial.

Accordingly, there is the possibility of improvement in satisfying both saving resources and acquiring information corresponding to actual printing results beforehand.

### SUMMARY

The present invention provides an improved image forming apparatus, system, and method that provide a preview image that corresponds to an actual printing result.

More specifically, the present invention provides an image forming apparatus that includes a communications unit that exchanges data and commands with an information processing apparatus, a drawing unit that generates drawing data from the image data received by the communications unit reflecting print setting data included in the image data, an image forming unit that forms and outputs an image on a recording medium based on the drawing data and the print setting data, a preview image generating unit that generates preview image data from the image data reflecting the print setting data, a preview image control unit that has the preview image generating unit generate the preview image data from the image data and sends the generated preview image data to the information processing apparatus via the communications unit in case a preview command is included in the image data received by the communications unit, and an image forming control unit that has the drawing unit generate drawing data based on the image data and the print setting data after the communications unit receives the image data, the print setting data, and a command to start printing and has the image forming unit form an image on a recording medium based on the generated image data.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a configuration of an image forming system as an embodiment of the present invention.

FIG. 2 is a sequence diagram illustrating an image forming control process as an embodiment of the present invention.

FIG. 3 is a sequence diagram illustrating another image forming control process as an embodiment of the present invention.

FIG. 4 is a sequence diagram illustrating an image forming control process in case an image forming apparatus starts printing as an embodiment of the present invention.

FIG. 5 is a sequence diagram illustrating an image forming control process that takes preset print settings into account as an embodiment of the present invention.

FIG. 6 is a sequence diagram illustrating the image forming control process continued from FIG. 5 as an embodiment of the present invention.

FIG. 7 is a diagram illustrating preset print settings as an embodiment of the present invention.

FIG. 8 is a sequence diagram illustrating an image forming control process that takes preset print settings for each user into account as an embodiment of the present invention.

FIG. 9 is a sequence diagram illustrating the image forming control process continued from FIG. 8 as an embodiment of the present invention.

FIGS. 10A, 10B, and 10C are diagrams illustrating preset print settings for each user as an embodiment of the present invention.

FIG. 11 is a sequence diagram illustrating an image forming control process in case of generating a preview image in HTML format as an embodiment of the present invention.

FIG. 12 is a sequence diagram illustrating the image forming control process continued from FIG. 11 as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the present invention will be described in detail below with reference to the drawings.

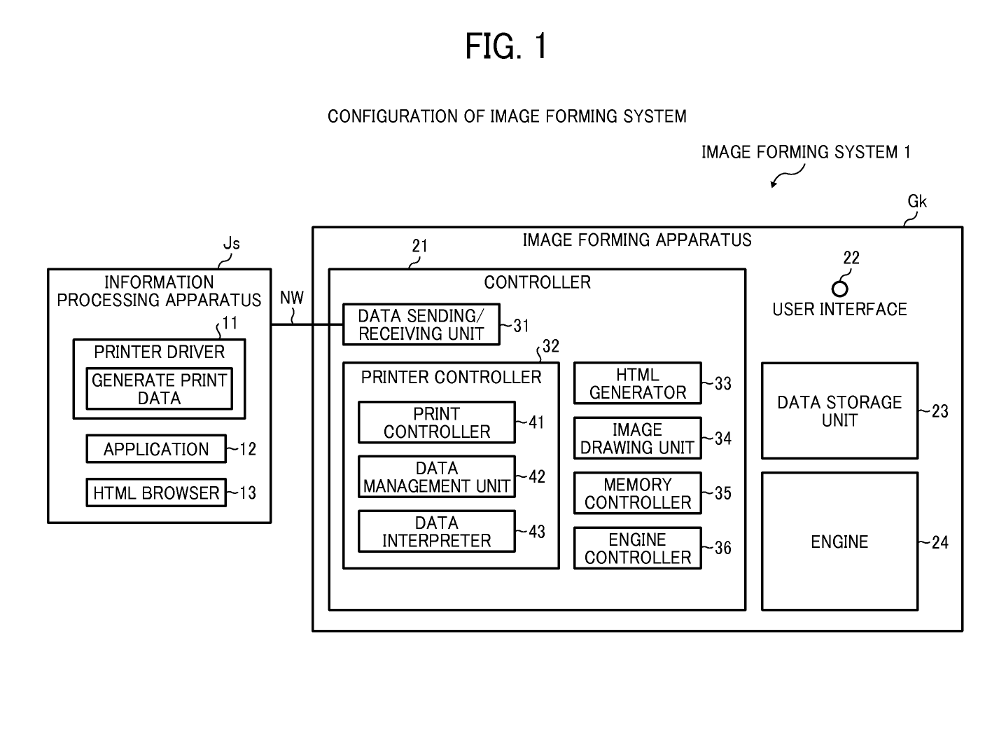

FIG. 1 is a diagram illustrating a configuration of an image forming system 1 of the first embodiment in the present invention.

In FIG. 1, an information processing apparatus Js and an image forming apparatus Gk are connected via a network NW such as LAN in the image forming system 1. Although only one information processing apparatus Js is illustrated in FIG. 1, a plurality of the image processing apparatuses Js can be connected to the network NW, and each of the image processing apparatus Js can request the image forming apparatus Gk to print out. Also, in the image forming system 1, a plurality of the image forming apparatus Gk can be connected to the network NW, and the network NW can be either wired or wireless.

After image data and print settings are specified, the information processing apparatus Js sends the print setting data and the print data to the image forming apparatus Gk and requests to generate a preview image. After receiving the preview image, the information processing apparatus Js displays the preview image data on a preview image display. After modifying the print setting data and receiving command to start printing, the information processing apparatus Js sends the image data, print setting data, and the command to start printing to the image forming apparatus Gk and has the image forming apparatus Gk execute printing according to the specified print setting data.

Personal computers that have a general-purpose hardware configuration and are equipped with a display and an input device such as a keyboard and a mouse may be used as the information processing apparatus Js. Also, the information processing apparatus Js has a printer driver 11, one or more applications 12, a Hyper Text Markup Language (HTML) browser 13, and an Operating System (OS) (not shown in figures) as its software configuration.

The information processing apparatus Js is equipped with the printer driver 11, the applications 12 such as document creating software, drawing software, spreadsheet software, and database software, and the HTML browser 13 on the OS. If a command to print a document (image data) created by the application 12 is issued from the application 12, the information processing apparatus Js sends the image data to the printer driver 11 via the OS.

A driver that corresponds to the image forming apparatus Gk connected to the network NW is installed in the information processing apparatus Js as the printer driver 11. The printer driver 11 sends the image data from the application 12 to the image forming apparatus Gk after converting the image data into print data suited for the destination image forming apparatus and sends print setting data, a command to request preview, and a command to start printing to the image forming apparatus Gk after generating them.

After receiving the preview image data from the image forming apparatus Gk via the network NW, the printer driver 11 and the application 12 in the information processing apparatus Js display the preview image on the display. If a user modifies print settings and starts printing using the input devices in response to displaying the preview image, the printer driver 11 sends the print data, the modified print setting data, and the command to start printing if necessary to the image forming apparatus Gk via the network NW. If the user starts printing without modifying the print settings, the printer driver 11 sends the print data and the command to start printing if necessary to the image forming apparatus Gk via the network NW. It should be noted that, after receiving a Uniform Resource Locator (URL) that indicates HTML that includes the preview image from the image forming apparatus Gk, the HTML browser 13 in the information processing apparatus Js accesses the URL and displays the HTML that includes the preview image on the display.

The image forming apparatus GK includes a controller 21, a user interface 22, a data storage unit 23, and an engine unit 24 etc. and is connected to the information processing apparatus Js via the network NW.

The controller 21 includes a data sending/receiving unit 31, a printer controller 32, a HTML generator 33, an image drawing unit 34, a memory controller 35, and an engine 36 etc., and the printer controller 32 that includes a print controller 41, a data management unit 42, and a data interpreter 43 etc.

The controller 21 includes a Central Processing Unit (CPU), a Read Only Memory (ROM), and a Random Access Memory (RAM) etc. (not shown) The CPU controls each unit in the image forming apparatus Gk based on a program in the ROM using the RAM as work memory and executes an image forming control method that forms an image after providing a preview image according to an actual print result of the present invention. The controller 21 functions as a preview image control method and an image forming control method.

The image forming apparatus Gk executes the image forming control method that forms an image after providing a preview image that corresponds to an actual print result (described later) by reading an image forming control program that executes the image forming control method of the present invention recorded on computer-readable media such as the ROM, an Electrically Erasable and Programmable Read Only Memory (EEPROM), an EPROM, a flash memory, a floppy disk, a Compact Disc Read Only Memory (CD-ROM), a Compact Disc Rewritable (CD-RW), a Digital Versatile Disk (DVD), a Secure Digital (SD) card, a Magneto-Optical Disc (MO) etc., and installing it in the RAM etc. The image forming control program is a computer-executable program written by legacy programming languages and object oriented programming languages such as assembler, C, C++, C#, and Java and can be distributed stored in the recording media described above.

The user interface 22 includes operation keys necessary to control the image forming apparatus Gk (at least a print settings modifying key that inputs print settings such as consolidate print and a print start key that starts printing) and can also include a display to display information such as preview images, etc. The user interface 22 outputs content of key operations to the controller 21 and displays display information from the controller 21 on the display if equipped with the display.

Large-capacity non-volatile storage devices such as hard disk drives (HDDs) are used for the data storage unit 23 (storage unit, print settings storing unit). Information such as received print data (image data), print setting data, and draw data and preview images etc. generated by the image drawing unit 34 in the controller 21 is read from/written to the data storage unit 23 under the control of the controller 21.

The engine unit 24 (image forming unit) includes at least a printer engine and can also be equipped with a scanner engine that scans an image of a document and a facsimile engine that communicates via facsimile etc.

For example, an electrophotographic printer engine is used for the printer engine of the engine unit 24. The printer engine of the engine unit 24 forms an image and outputs it on a recording medium such as paper or film.

The data sending/receiving unit 31 (communications unit) of the controller 21 is connected to the information processing apparatus Js via the network NW and sends/receives data and commands to/from the image processing apparatus Js.

The printer controller 32 controls printing at the engine unit 24 based on print data and print setting data.

The print controller 41 of the printer controller 32 acquires print data and print setting data received by the data sending/receiving unit 31 and controls storing data in the data storage unit 23 and printing at the printer engine. The data management unit 42 manages the data storage unit 23, monitors print data, print setting data, and a preview image stored in the data storage unit 23, and sends appropriate data to other control units.

The data interpreter 43 interprets printer job control language (PJL) and printer description language (PDL) in print data, controls converting print data into drawing data for the image drawing unit 34, and controls generating a preview image etc.

The HTML generator 33 operates only in case of generating HTML that includes a preview image and sending a URL of the HTML. That is, in case of sending a URL of HTML that includes a preview image, the HTML generator 33 generates HTML in which a preview image of drawing data for printing is embedded and has the data sending/receiving unit 31 send the URL only to the information processing apparatus Js.

The image drawing unit 34 (drawing unit and preview image generating unit) generates drawing data from print data based on the interpretation result provided by the data interpreter 43 and sends the drawing data and print setting data to the memory controller 35 and engine controller 36. Also, the image drawing unit 34 generates a preview image from the print data based on the interpretation result provided by the data interpreter 43.

The memory controller 35 controls various memory devices, especially at the time of storing print data, print setting data, and drawing data in the data storage unit 23 and reading print data, print setting data, and drawing data from the data storage unit 23.

The engine controller 36 controls operations of the engine unit 24 and controls forming images by the printer engine, scanning documents by the scanner engine, and communicating by facsimile using the facsimile engine.

Next, operations of the present invention are described below.

In the image forming system 1 of the present invention, the image forming apparatus Gk generates a preview image that corresponds to an actual printing result based on print data and print setting data from the information processing apparatus Js and sends the preview image to the information processing apparatus Js.

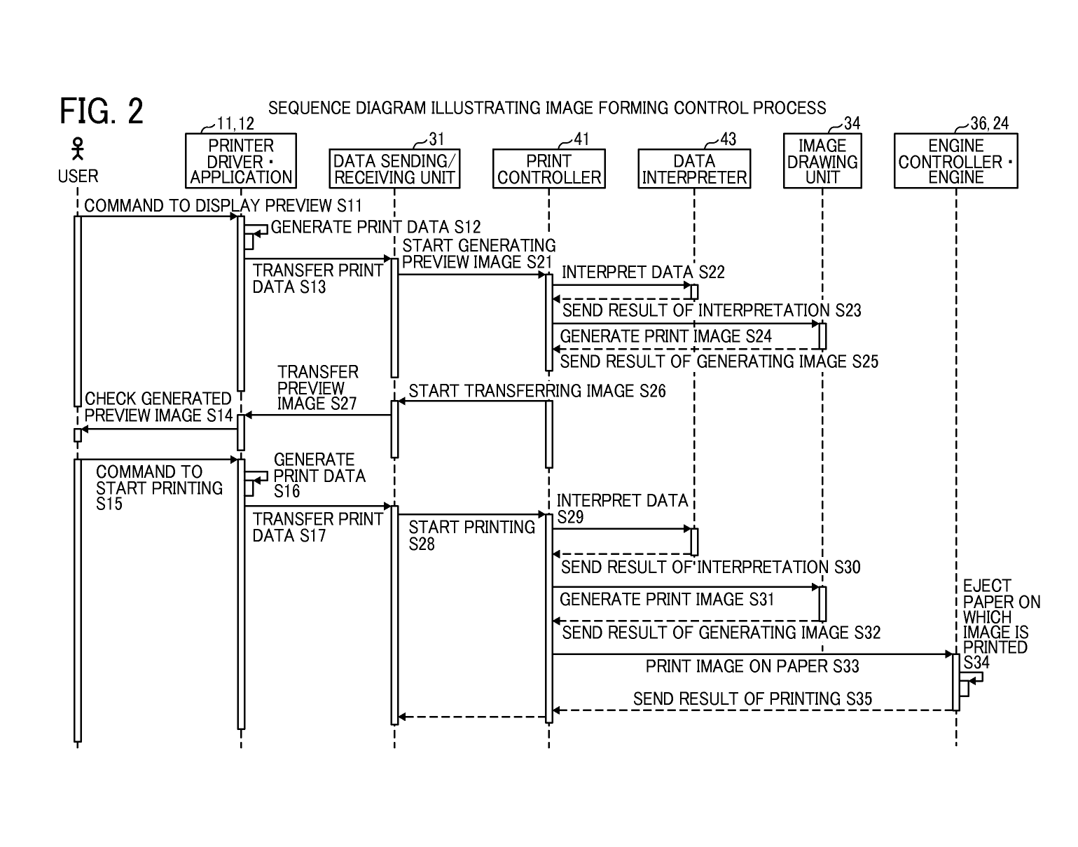

That is, as shown in FIG. 2, in the image forming system 1, if a user specifies image data, inputs print settings, and commands to display a preview operating the input devices of the information processing apparatus Js (S11), the printer driver 11 and the application 12 generate print data and print setting data from the specified image data and print settings (S12) and send the generated print data, the print setting data, and a command to display a preview to the data sending/receiving unit 31 in the image forming apparatus Gk via the network NW (S13).

In the image forming apparatus Gk, after transferring the print data, the print setting data, and the command to display the preview from the information processing apparatus Js, the data sending/receiving unit 31 receives the print data, the print setting data, and the command to display the preview, sends the print data, the print setting data, and the command to display the preview to the print controller 41, and requests the print controller 41 to start generating a preview image (S21). Subsequently, the print controller 41 sends the print data and the print setting data to the data interpreter 43, and the data interpreter 43 interprets the data (S22).

After interpreting the data, the data interpreter 43 sends the interpretation result to the print controller 41 (S23). Subsequently, the print controller 41 sends the interpretation result, the print data, and the print setting data to the image drawing unit 34 (S24), and the image drawing unit 34 generates drawing data and preview image data that corresponds to the print settings and sends them to the print controller 41 (S25).

The print controller 41 sends the preview image data to the data sending/receiving unit 31 and requests to transfer the data (S26). The data sending/receiving unit 31 sends the received preview image data to the information processing apparatus Js (S27).

In the information processing apparatus Js, after receiving the preview image data, the printer driver 11 and the application 12 display the preview image on the display (S14). If a user browses the preview image and then starts printing after modifying print settings if necessary (S15), the printer driver 11 and the application 12 generate print data and print setting data from the image data and the print settings (S16) and send the generated print data, print setting data, and the command to start printing to the data sending/receiving unit 31 in the image forming apparatus Gk via the network NW (S17).

In the image forming apparatus Gk, after transferring the print data, the print setting data, and the command to print from the information processing apparatus Js, the data sending/receiving unit 31 receives the print data, the print setting data, and the command to print, sends the print data, the print setting data, and the command to print to the print controller 41, and requests the print controller 41 to start generating a preview image (S28). Subsequently, the print controller 41 sends the print data and the print setting data to the data interpreter 43, and the data interpreter 43 interprets the data (S29).

After interpreting the data, the data interpreter 43 sends the interpretation result to the print controller 41 (S30). Subsequently, the print controller 41 sends the interpretation result, the print data, and the print setting data to the image drawing unit 34 (S31), and the image drawing unit 34 generates drawing data and preview image data that corresponds to the print settings and sends them to the print controller 41 (S32).

The print controller 41 sends the drawing data and the print setting data to the engine controller 36 and commands to print (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

In the information processing apparatus Js, after receiving the printing result, the printer driver 11 and the application 12 display the printing result on the display.

As described above, in the image forming system 1 of the present invention, the image forming apparatus Gk includes the data sending/receiving unit 31 (communications unit) that communicates data and commands with the information processing apparatus Js, the image drawing unit 34 (drawing unit) that generates drawing data from the print data (image data) received by the data sending/receiving unit 31 that reflects the print setting data included in the print data and generates preview image data from the print data reflecting the print setting data, the engine unit 24 (image forming unit) that forms and outputs an image on a recording medium based on the drawing data and the print setting data, and the print controller 41 (preview image control unit) that has the image drawing unit 34 generate the preview image data from the print data and sends the generated preview image data to the information processing apparatus Js via the data sending/receiving unit 31 in case a command to display a preview is included in the print data received by the data sending/receiving unit 31, and has the image drawing unit 34 generate drawing data based on the print data and the print setting data after the data sending/receiving unit 31 receives the print data, the print setting data, and a command to start printing and has the engine unit 24 form an image on a recording medium based on the generated drawing data.

Accordingly, after receiving print data, print setting data, and a command to display a preview from the information processing apparatus Js, the image forming apparatus Gk can generate and provide a preview image that corresponds to the actual printing result, and that can avoid waste of resources by the trial print and checking the preview image that corresponds to the actual printing result in advance.

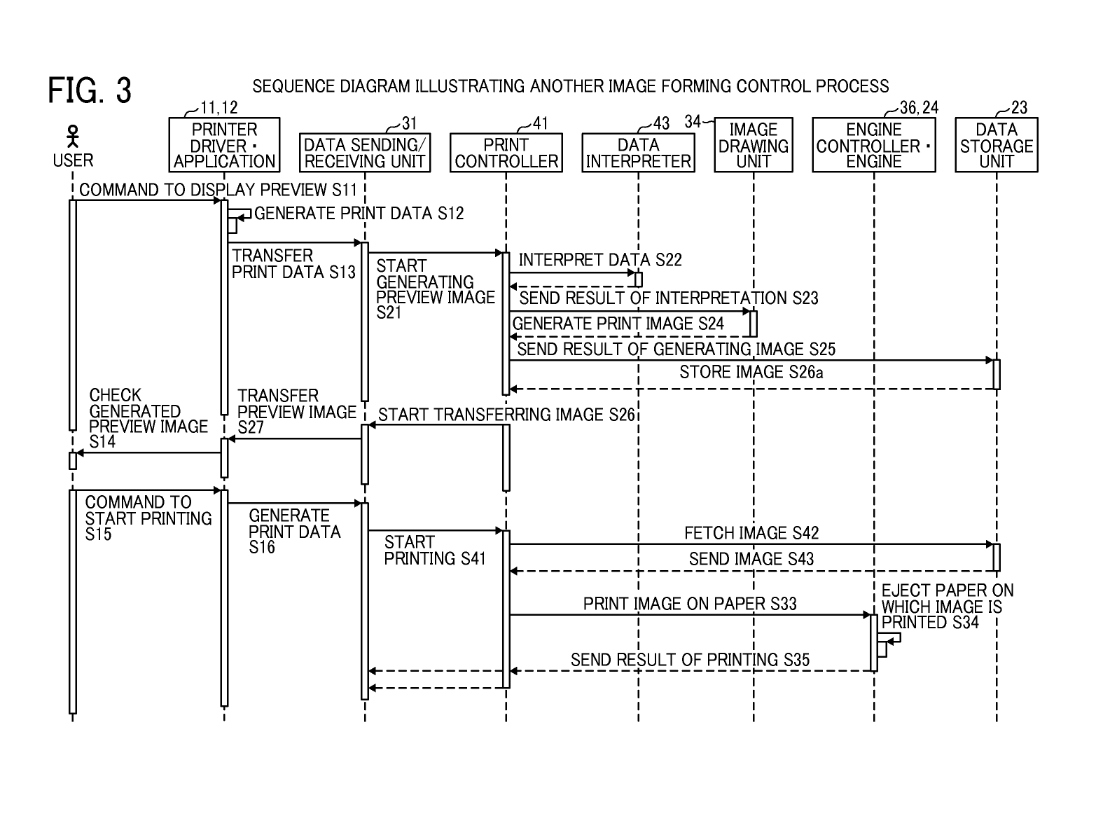

It should be noted that, although the information processing apparatus Js generates print data and sends it to the image forming apparatus Gk again even after checking the preview image in the above description, the image forming apparatus Gk can also store the generated drawing data sent at the time of requesting preview in the data storage unit 23 and use the stored drawing data for printing to prevent the information processing apparatus Js from sending the print data again as shown in FIG. 3. It should be noted that the same step numbers as in FIG. 2 are assigned to the same steps in FIG. 3 and descriptions for those steps are omitted or simplified.

As shown in FIG. 3, in the image forming system 1, after a user specifies image data, inputs print settings, and requests to display a preview operating the input device of the information processing apparatus Js (S11), the printer driver 11 and the application 12 generate print data and print setting data from the specified image data and the print settings (S12), and the generated print data, the print setting data, and the command to request to display the preview are sent to the data sending/receiving unit 31 in the image forming apparatus Gk via the network NW (S13).

In the image forming apparatus Gk, after transferring the print data, the print setting data, and the command to request the preview from the information processing apparatus Js, the data sending/receiving unit 31 receives the print data, the print setting data, and the command to request the preview and starts generating the preview image passing the print data, the print setting data, and the command to request to display the preview to the print controller 41 (S21). Subsequently, the print controller 41 sends the print data and the print setting data to the data interpreter 43, and the data interpreter 43 interprets the data (S22).

After interpreting the data, the data interpreter 43 sends the interpretation result to the print controller 41 (S23), and the print controller 41 sends the interpretation result, the print data, and the print setting data to the image drawing unit 34 (S24). Subsequently, the image drawing unit 34 generates drawing data and preview image data that corresponds to the print settings and sends them to the print controller 41 (S25).

The print controller 41 stores the drawing data in the data storage unit 23 via the memory controller 35 (S26a) and requests the data sending/receiving unit 31 to transfer data sending the preview image data to the data sending receiving unit 31 (S26). Subsequently, the data sending/receiving unit 31 sends the received preview image data to the information processing apparatus Js (S27).

In the information processing apparatus Js, after transferring the preview image data, the printer driver 11 and the application 12 display the preview image on the display (S14). If the user starts printing after modifying print settings from the input device if necessary after browsing the preview image (S15), the printer driver 11 and the application 12 generate the necessary modified print setting data and send the generated necessary modified print setting data, print data specifying data that specifies the print data, and the command to start printing to the data sending/receiving unit 31 in the image forming apparatus Gk via the network NW (S16).

In the image forming apparatus Gk, after receiving the necessary modified print setting data, the print data specifying data, and the command to start printing, the print controller 41 acquires the drawing data that corresponds to the print data specifying data from the data storage unit 23 (S42), acquires the drawing data and the print setting data (S43), and requests the engine controller 36 to start printing sending the drawing data to the engine controller 36 if there is no modified print setting data (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

Although not shown in FIG. 3, in the image forming apparatus Gk, after receiving the necessary modified print setting data from the data sending/receiving unit 31, the print controller 41 sends the drawing data and the necessary modified print setting data to the image drawing unit 34. The image drawing unit 34 generates the drawing data that corresponds to the modified print setting data and sends it to the print controller 41. Subsequently, as described above, the print controller 41 sends the drawing data to the engine controller 36 and commands to print (S33). The engine controller 36 has the printer engine in the engine unit 24 form an image on paper based on the received drawing data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

As described above, in the image forming system 1 in this embodiment, the image forming apparatus Gk includes the data storage unit 23 that stores the drawing data and the print setting data generated by the image drawing unit 34. After the data sending/receiving unit 31 receives the specifying data that specifies the drawing data stored in the data storage unit 23 and the command to start printing, the print controller 41 has the engine unit 24 form an image on paper based on the drawing data specified by the specifying data and the print setting data. After the data sending/receiving unit 31 receives the specifying data, the print setting data, and the command to start printing, the print controller 41 has the image drawing unit 34 generate drawing data newly based on the drawing data specified by the specifying data and the print setting data, and has the engine unit 24 form an image on paper based on the generated drawing data and the print setting data.

Accordingly, if the command to start printing is sent for the preview image that corresponds to the actual printing result provided by generating the drawing data once, printing can be executed without generating drawing data, and that enhances the processing speed and reduces the processing burden.

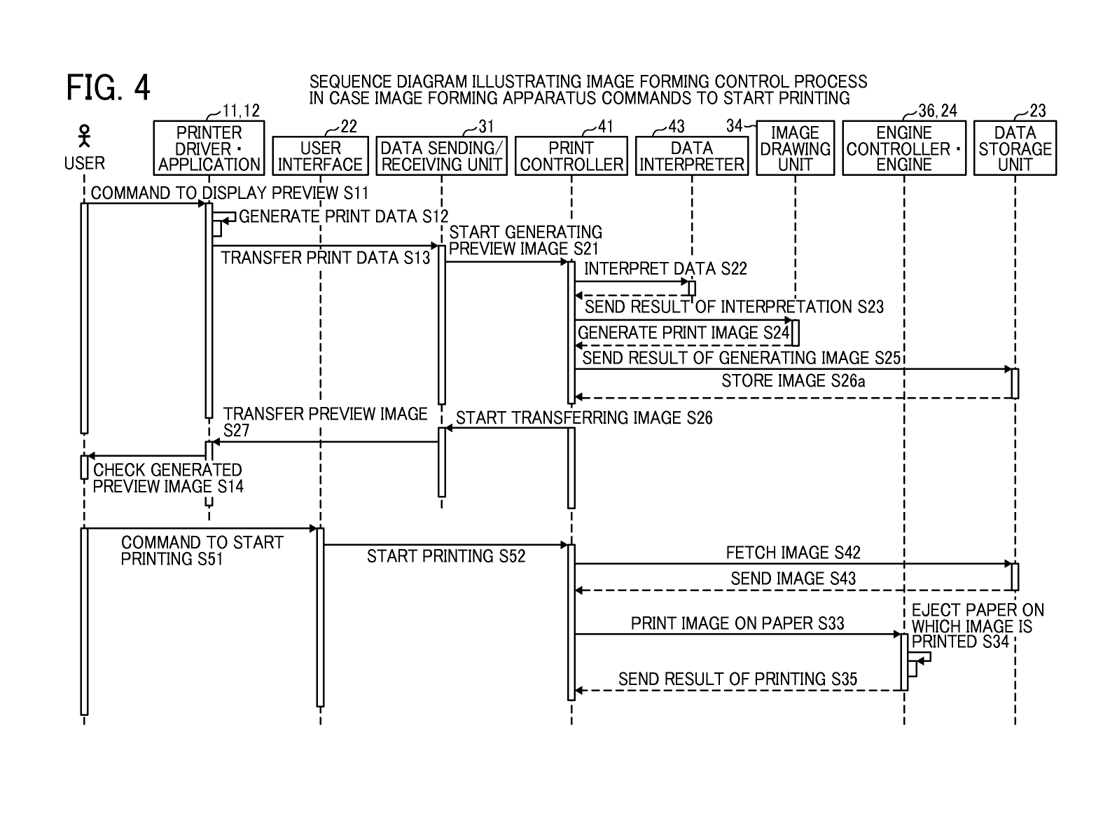

Although printing after preview is started by sending the command to start printing from the information processing apparatus Js to the image forming apparatus Gk in the above description, the printing after preview can also be started by operating the user interface 22 of the image forming apparatus Gk to command to start printing as shown in FIG. 4. It should be noted that the same step numbers as in FIG. 2 and FIG. 3 are assigned to the same steps in FIG. 4 and descriptions for those steps are omitted or simplified.

As shown in FIG. 4, in the image forming system 1, after a user specifies image data, inputs print settings, and requests to display a preview operating the input device of the information processing apparatus Js (S11), the printer driver 11 and the application 12 generate print data and print setting data from the specified image data and the print settings (S12), and the generated print data, the print setting data, and the command to request to display the preview are sent to the data sending/receiving unit 31 in the image forming apparatus Gk via the network NW (S13).

In the image forming apparatus Gk, after transferring the print data, the print setting data, and the command to request the preview from the information processing apparatus Js, the data sending/receiving unit 31 receives the print data, the print setting data, and the command to request the preview and starts generating the preview image passing the print data, the print setting data, and the command to request to display the preview to the print controller 41 (S21). Subsequently, the print controller 41 sends the print data and the print setting data to the data interpreter 43, and the data interpreter 43 interprets the data (S22).

After interpreting the data, the data interpreter 43 sends the interpretation result to the print controller 41 (S23), and the print controller 41 sends the interpretation result, the print data, and the print setting data to the image drawing unit 34 (S24). Subsequently, the image drawing unit 34 generates drawing data and preview image data that corresponds to the print settings and sends them to the print controller 41 (S25).

The print controller 41 stores the drawing data in the data storage unit 23 via the memory controller 35 (S26a) and requests the data sending/receiving unit 31 to transfer data sending the preview image data to the data sending receiving unit 31 (S26). Subsequently, the data sending/receiving unit 31 sends the received preview image data to the information processing apparatus Js (S27).

In the information processing apparatus Js, after transferring the preview image data, the printer driver 11 and the application 12 display the preview image on the display (S14). After browsing the preview image, the user moves to the place where the image forming apparatus Gk is located and starts printing by specifying the print data and operating a start print key on the user interface 22 of the image forming apparatus Gk (S51).

In the image forming apparatus Gk, after commanding to start printing specifying the print data on the user interface 22, the print controller 41 receives the print data specifying data and the command to start printing (S52), acquires the drawing data that corresponds to the print data specifying data from the data storage unit 23 (S42), acquires the drawing data and the print setting data (S43), and requests the engine controller 36 to start printing sending the drawing data to the engine controller 36 if there is no modified print setting data (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

As described above, in the image forming system 1 in this embodiment, the image forming apparatus Gk includes the user interface 22 on which the command to start printing that specifies the drawing data stored in the data storage unit 23 and starts printing is input by operating the user interface 22. After inputting the command to start printing that specifies the drawing data from the user interface 22, the print controller 41 has the image drawing unit 34 generate drawing data based on the specified drawing data and the print setting data stored in the data storage unit 23, or based on the drawing data, the print setting data, and the print settings and has the engine unit 24 form an image on paper based on the drawing data.

Accordingly, printing can be started at the installation location of the image forming apparatus Gk after checking the preview image that corresponds to the actual printing result, and that reduces resources waste and enhances security.

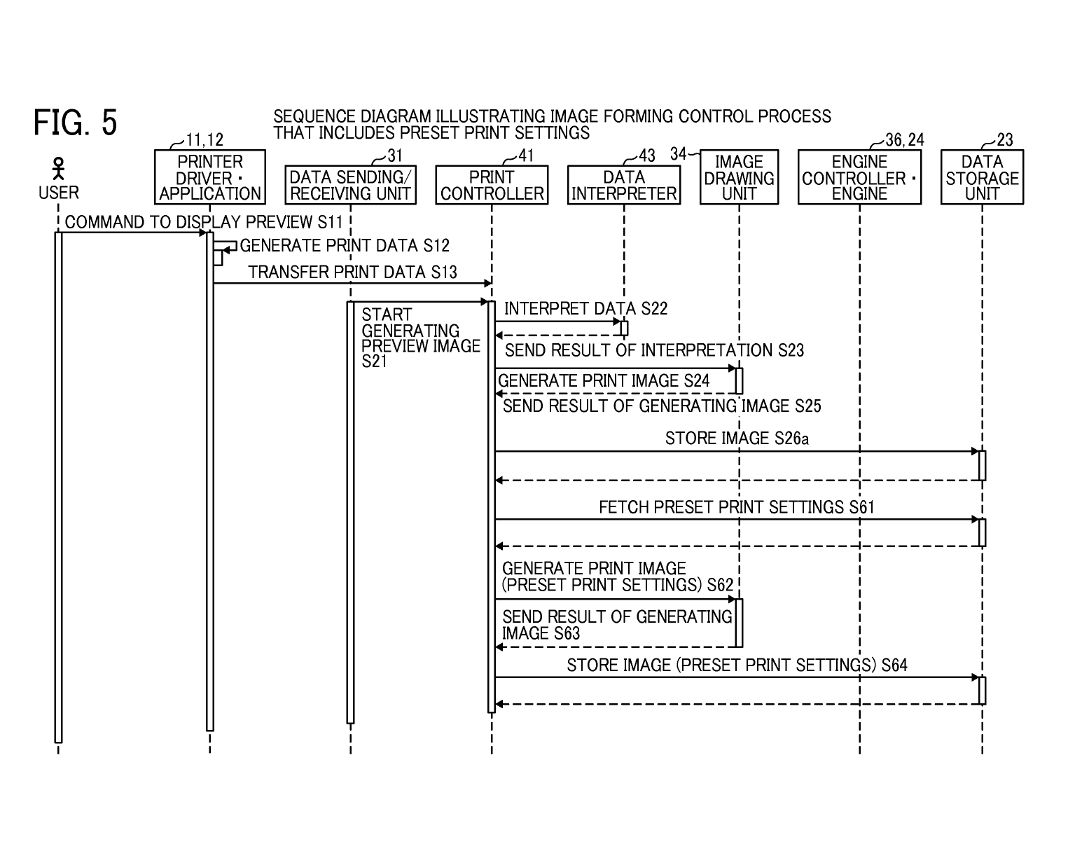

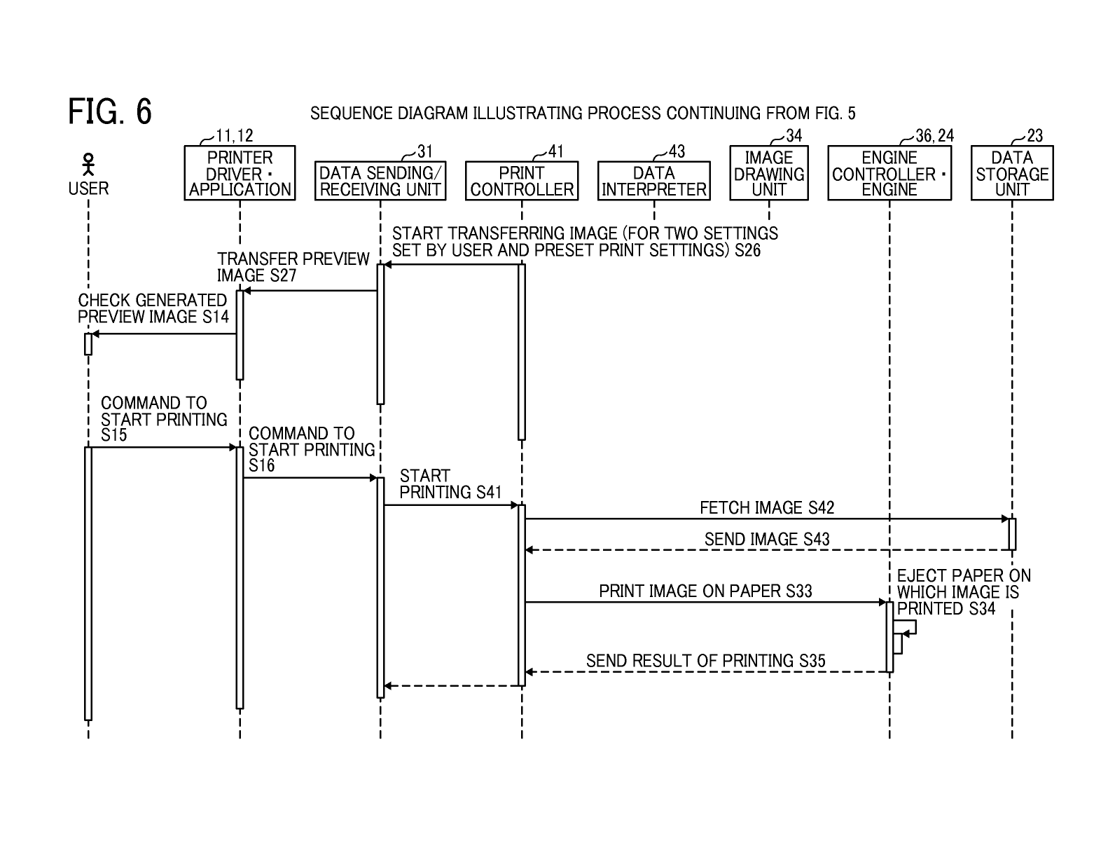

Although the preview image is generated in the image forming apparatus Gk based on the image data and the print setting data from the information processing apparatus Js in the above description, regarding generating a preview image, a preview image considering print settings preset in the image forming apparatus Gk can also be generated as shown in FIG. 5 and FIG. 6. It should be noted that FIG. 5 and FIG. 6 are applied to a case in which an image is formed using print data or drawing data stored in the data storage unit 23 of the image forming apparatus Gk as same as FIG. 3, and the same step numbers as in FIG. 2 and FIG. 3 are assigned to the same steps in FIG. 5 and FIG. 6 and descriptions for those steps are omitted or simplified.

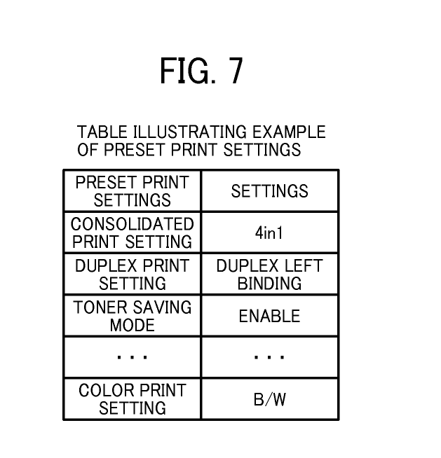

It should be noted that preset print settings include settings such as consolidated printing that prints four pages of images in one sheet, duplex printing, enabling/disabling to save toner, and color settings such as b/w and full color as shown in FIG. 7. Preset print settings are set from the user interface 22, etc., in advance and stored in the data storage unit 23, etc., as preset print setting table etc.

As shown in FIG. 5, in the image forming system 1, after a user specifies image data, inputs print settings, and requests to display a preview operating the input device of the information processing apparatus Js (S11), the printer driver 11 and the application 12 generate print data and print setting data from the specified image data and the print settings (S12), and the generated print data, the print setting data, and the command to request to display the preview are sent to the data sending/receiving unit 31 in the image forming apparatus Gk via the network NW (S13).

In the image forming apparatus Gk, after transferring the print data, the print setting data, and the command to request the preview from the information processing apparatus Js, the data sending/receiving unit 31 receives the print data, the print setting data, and the command to request the preview and starts generating the preview image passing the print data, the print setting data, and the command to request to display the preview to the print controller 41 (S21). Subsequently, the print controller 41 sends the print data and the print setting data to the data interpreter 43, and the data interpreter 43 interprets the data (S22).

After interpreting the data, the data interpreter 43 sends the interpretation result to the print controller 41 (S23), and the print controller 41 sends the interpretation result, the print data, and the print setting data to the image drawing unit 34 (S24). Subsequently, the image drawing unit 34 generates drawing data and preview image data that corresponds to the print settings and sends them to the print controller 41 (S25).

The print controller 41 stores the drawing data in the data storage unit 23 via the memory controller 35 (S26a) and acquires preset print settings from the data storage unit 23 (S61). Subsequently, the print controller 41 sends the acquired preset print settings to the image drawing unit 34 (S62), and the image drawing unit 34 generates drawing data and preview image data that corresponds to the preset print settings from the firstly generated drawing data and preview image data (S63).

The print controller 41 stores the drawing data in the data storage unit 3 via the memory controller 35 (S64) and requests the data sending/receiving unit 31 to transfer the data sending the preview image data as shown in FIG. 6 (S26). Subsequently, the data sending/receiving unit 31 sends the received preview image data to the information processing apparatus Js (S27).

In the information processing apparatus Js, after receiving the preview image data, the printer driver 11 and the application 12 display the preview image on the display (S14). If a user browses the preview image and starts printing after modifying print settings if necessary (S15), the printer driver 11 and the application 12 generate the necessary modified print setting data and send the generated necessary modified print setting data, print data specifying data that specifies the print data, and the command to start printing to the data ending/receiving unit 31 in the image forming apparatus Gk via the network NW (S16).

In the image forming apparatus Gk, after transferring the necessary modified print setting data, the print data specifying data, and the command to request to start printing, the data sending/receiving unit 31 sends the necessary modified print setting data, the print data specifying data, and the command to request to start printing to the print controller 41 (S41).

After receiving the necessary modified print setting data, the print data specifying data, and the command to start printing, the print controller 41 acquires the drawing data that corresponds to the print data specifying data from the data storage unit 23 (S42), acquires the drawing data and the print setting data (S43), and requests the engine controller 36 to start printing sending the drawing data to the engine controller 36 if there is no modified print setting data (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

Although not shown in FIG. 6, in the image forming apparatus Gk, after receiving the necessary modified print setting data from the data sending/receiving unit 31, the print controller 41 sends the drawing data and the necessary modified print setting data to the image drawing unit 34. The image drawing unit 34 generates the drawing data that corresponds to the modified print setting data and the preset print settings and sends it to the print controller 41. Subsequently, as described above, the print controller 41 sends the drawing data to the engine controller 36 and commands to print (S33). The engine controller 36 has the printer engine in the engine unit 24 form an image on paper based on the received drawing data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

As described above, in the image forming system 1 in this embodiment, the image forming apparatus Gk includes the user interface 22 on which print settings are input and the data storage unit 23 that stores the print settings input on the user interface 22, and the image drawing unit 34 generates drawing data that reflects the print setting data and the print settings from the print data and generates preview image data that reflects the print setting data and the print settings from the print data.

Accordingly, a preview image that reflects print settings such as consolidated print and toner saving print, etc., set on the image forming apparatus Gk in advance and used in the actual printing can be provided, and the user can check a preview image that corresponds to the actual printing result in advance while preventing resource waste.

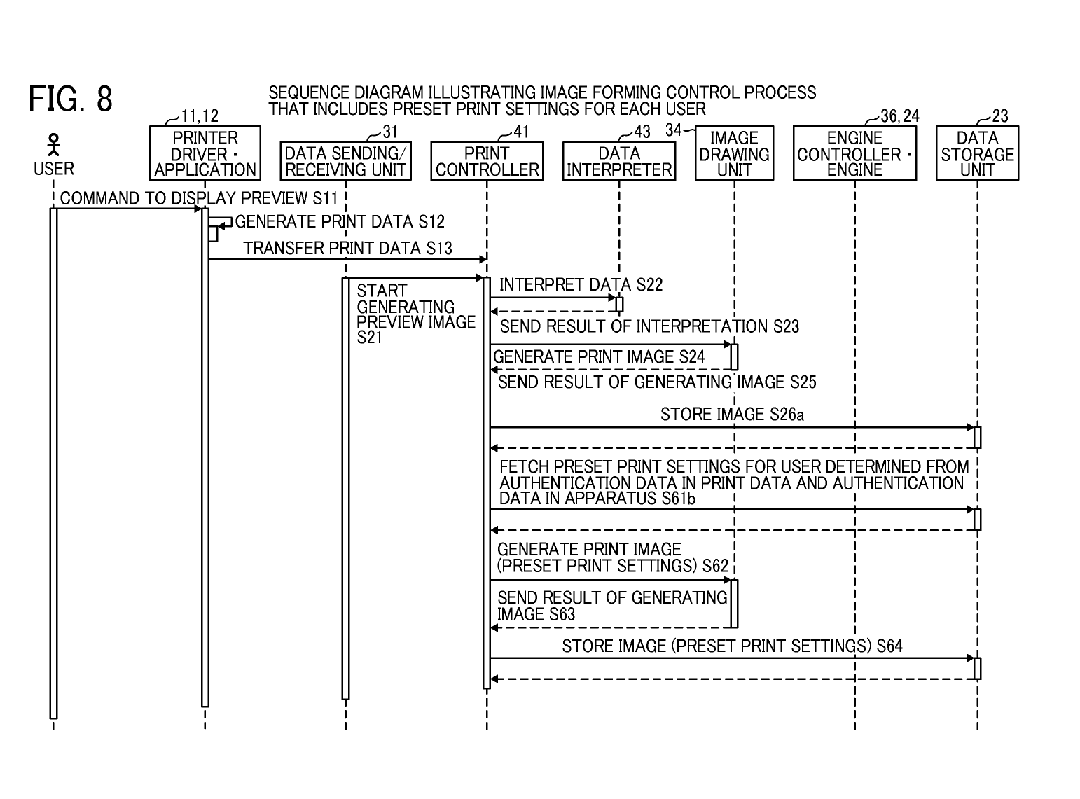

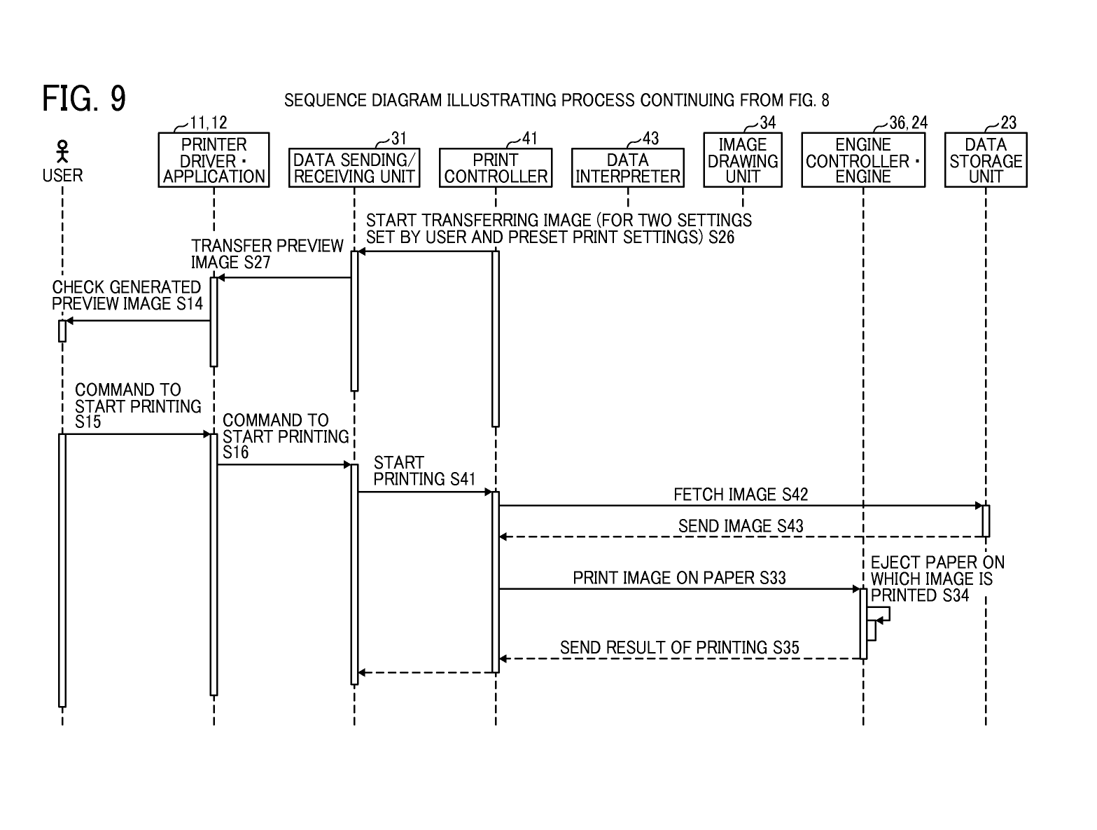

In the above description, in case of generating a preview image that takes preset print settings into account, preset print settings are stored for each user, and preview images that take preset print settings according to each user can be generated as shown in FIG. 8 and FIG. 9. It should be noted that FIG. 8 and FIG. 9 are applied to a case in which an image is formed using print data or drawing data stored in the data storage unit 23 of the image forming apparatus Gk as same as FIG. 3, and the same step numbers as in FIG. 2 and FIG. 3 are assigned to the same steps in FIG. 8 and FIG. 9 and descriptions for those steps are omitted or simplified.

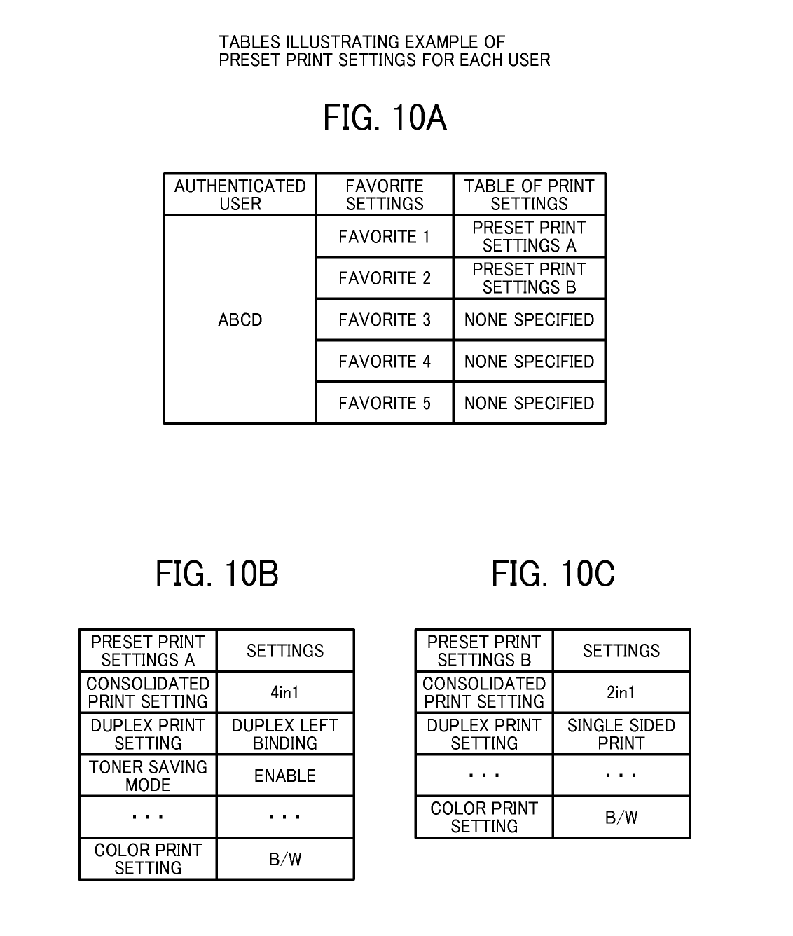

A user preset print settings table that associates favorite settings such as favorite settings 1 and favorite settings 2, etc., with names of preset print settings such as preset print settings A and preset print settings B for each user (A, B, C, and D in FIG. 10A) as shown in FIG. 10A. Individual preset print settings tables that indicate content of preset print settings for each name of preset print settings as shown in FIGS. 10B and 10C are set on the user interface 22, etc., in advance, and preset print settings for each user are stored as the preset print settings table for each user and the individual preset print settings table in the data storage 23, etc.

As shown in FIG. 8, in the image forming system 1, after a user specifies image data, inputs print settings, inputs user authentication data to specify the user, and requests to display a preview operating the input device of the information processing apparatus Js (S11), the printer driver 11 and the application 12 generate print data and print setting data from the specified image data and the print settings (S12), and the generated print data, the print setting data, the user authentication data, and the command to request to display the preview are sent to the data sending/receiving unit 31 in the image forming apparatus Gk via the network NW (S13).

In the image forming apparatus Gk, after transferring the print data, the print setting data, the user authentication data, and the command to request the preview from the information processing apparatus Js, the data sending/receiving unit 31 receives the print data, the print setting data, the user authentication data, and the command to request the preview and starts generating the preview image passing the print data, the print setting data, and the command to request to display the preview to the print controller 41 (S21). Subsequently, the print controller 41 sends the print data and the print setting data to the data interpreter 43, and the data interpreter 43 interprets the data (S22).

After interpreting the data, the data interpreter 43 sends the interpretation result and the user authentication data to the print controller 41 (S23), and the print controller 41 sends the interpretation result, the print data, and the print setting data to the image drawing unit 34 (S24). Subsequently, the image drawing unit 34 generates drawing data and preview image data that corresponds to the print settings and sends them to the print controller 41 (S25).

The print controller 41 stores the drawing data, the user authentication data, and the preview image data with corresponding to the user authentication data in the data storage unit 23 via the memory controller 35 (S26a) and acquires preset print settings that correspond to the user authentication data from the data storage unit 23 (S61b). Subsequently, the print controller 41 sends the acquired preset print settings to the image drawing unit 34 (S62), and the image drawing unit 34 generates drawing data and preview image data that corresponds to the preset print settings corresponding to the user from the firstly generated drawing data and preview image data (S63).

The print controller 41 stores the drawing data in the data storage unit 23 via the memory controller 35 (S64) and requests the data sending/receiving unit 31 to transfer the data sending the preview image data as shown in FIG. 9 (S26). Subsequently, the data sending/receiving unit 31 sends the received preview image data to the information processing apparatus Js (S27).

In the information processing apparatus Js, after receiving the preview image data, the printer driver 11 and the application 12 display the preview image on the display (S14). If a user browses the preview image and then starts printing after modifying print settings if necessary (S15), the printer driver 11 and the application 12 generate the necessary modified print setting data and send the generated necessary modified print setting data, print data specifying data that specifies the print data, and the command to start printing to the data ending/receiving unit 31 in the image forming apparatus Gk via the network NW (S16).

In the image forming apparatus Gk, after transferring the necessary modified print setting data, the print data specifying data, and the command to request to start printing, the data sending/receiving unit 31 sends the necessary modified print setting data, the print data specifying data, and the command to request to start printing to the print controller 41 (S41).

After receiving the necessary modified print setting data, the print data specifying data, and the command to start printing, the print controller 41 acquires the drawing data that corresponds to the print data specifying data from the data storage unit 23 (S42), acquires the drawing data and the print setting data (S43), and requests the engine controller 36 to start printing sending the drawing data to the engine controller 36 if there is no modified print setting data (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

Although not shown in FIG. 9, in the image forming apparatus Gk, after receiving the necessary modified print setting data from the data sending/receiving unit 31, the print controller 41 sends the drawing data and the necessary modified print setting data to the image drawing unit 34. The image drawing unit 34 generates the drawing data that corresponds to the modified print setting data and the preset print settings and sends it to the print controller 41. Subsequently, as described above, the print controller 41 sends the drawing data to the engine controller 36 and commands to print (S33). The engine controller 36 has the printer engine in the engine unit 24 form an image on paper based on the received drawing data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

As described above, in the image forming apparatus Gk in the image forming system 1 in this embodiment, print settings are input corresponding to user information that specifies a user, the data storage unit 23 stores the input print settings corresponding to the user information, the data sending/receiving unit 31 receives the user information from the information processing apparatus Js, the image drawing unit 34 generates drawing data that reflects the print setting data and the print settings that correspond to the user information from print data and generates preview image data that reflects the print setting data and the print settings that correspond to the user information from print data

Accordingly, a preview image that reflects print settings such as consolidate print and toner saving print etc. set on the image forming apparatus Gk for each user in advance and used in actual printing can be provided, and the user can check a preview image that corresponds to actual printing result much more in advance with preventing waste of resources by trial print.

Although a preview image is sent in image data format in case of sending the preview image from the image forming apparatus Gk to the image processing apparatus Js in the above description, the preview image can also be sent by generating the preview image in HTML format and sending its URL.

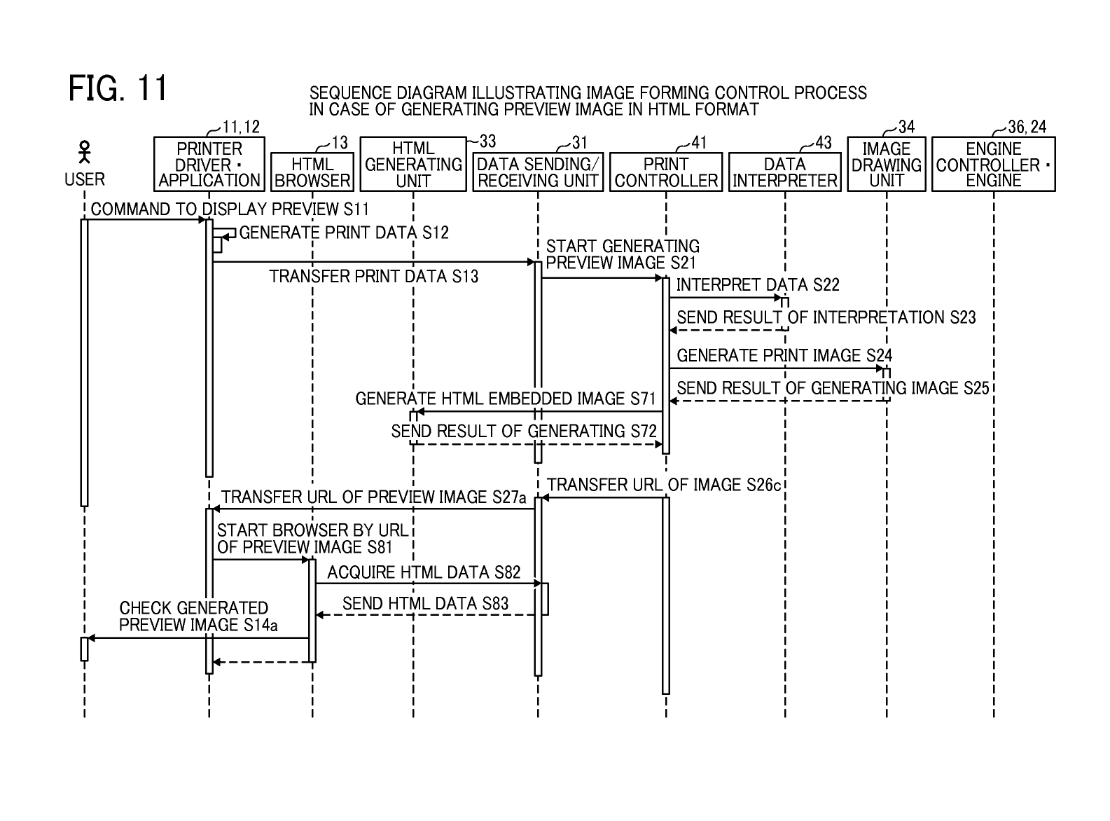

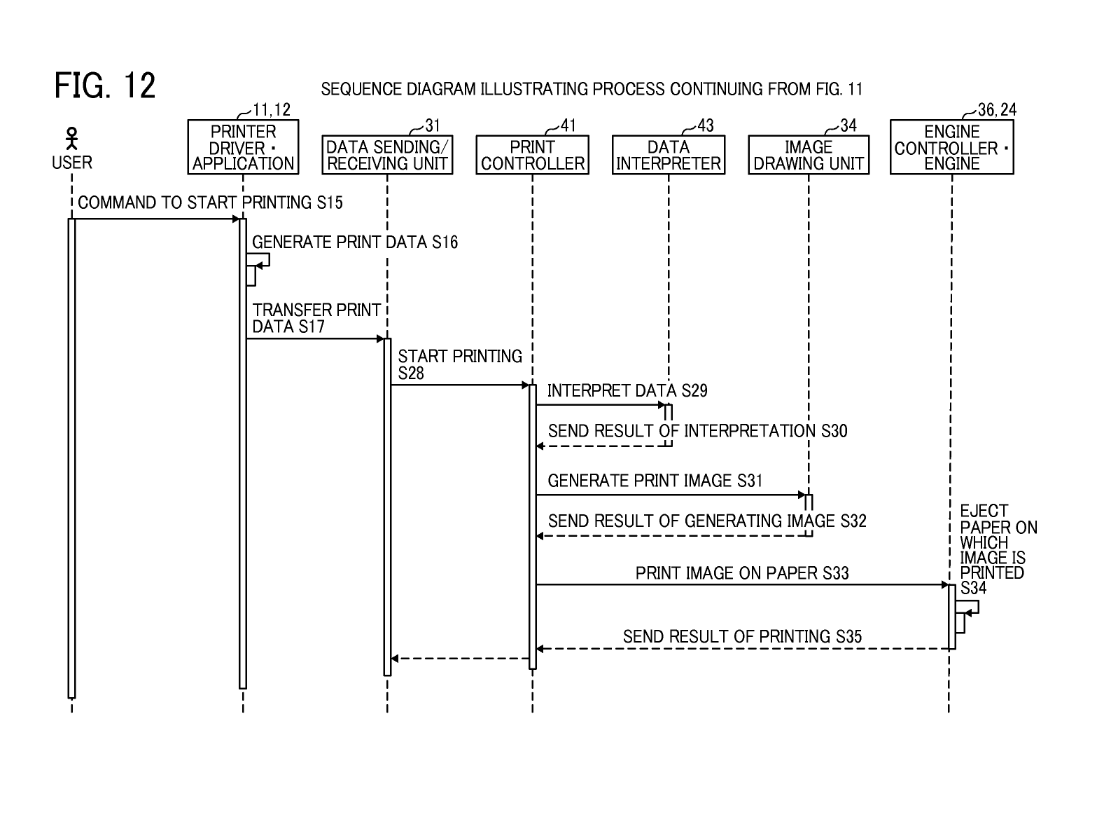

It should be noted that FIG. 11 and FIG. 12 are applied to a case in which the image forming apparatus Gk generates drawing data again if it is commanded to start printing after displaying a preview as in FIG. 2, and the same step numbers as in FIG. 2 are assigned to the same steps in FIG. 11 and FIG. 12 and descriptions for those steps are omitted or simplified. The process of sending a URL of a preview image formatted in HTML as shown in FIG. 11 and FIG. 12 can also be applied to the case of FIG. 3, FIG. 5 and FIG. 6, and FIG. 8 and FIG. 9.

As shown in FIG. 11, in the image forming system 1, after a user specifies image data, inputs print settings, and requests to display a preview operating the input device of the information processing apparatus Js (S11), the printer driver 11 and the application 12 generate print data and print setting data from the specified image data and the print settings (S12), and the generated print data, the print setting data, and the command to request to display the preview are sent to the data sending/receiving unit 31 in the image forming apparatus Gk via the network NW (S13).

In the image forming apparatus Gk, after transferring the print data, the print setting data, and the command to request the preview from the information processing apparatus Js, the data sending/receiving unit 31 receives the print data, the print setting data, and the command to request the preview and starts generating the preview image passing the print data, the print setting data, and the command to request to display the preview to the print controller 41 (S21). Subsequently, the print controller 41 sends the print data and the print setting data to the data interpreter 43, and the data interpreter 43 interprets the data (S22).

After interpreting the data, the data interpreter 43 sends the interpretation result to the print controller 41 (S23), and the print controller 41 sends the interpretation result, the print data, and the print setting data to the image drawing unit 34 (S24). Subsequently, the image drawing unit 34 generates drawing data and preview image data that corresponds to the print settings and sends them to the print controller 41 (S25).

The print controller 41 requests the HTML generator 33 to generate a HTML in which a preview image is embedded (S71), and the HTML generator 33 generates the HTML in which the preview image is embedded and sends it to the print controller 41 (S72).

The print controller 41 requests the data sending/receiving unit 31 to send the URL of the HTML in which the preview image is embedded to the information processing apparatus Js (S26c), and the data sending/receiving unit 31 sends the received URL of the HTML in which the preview image is embedded to the information processing apparatus Js (S27a).

In the image processing apparatus Js, after transferring the URL of HTML in which the preview image is embedded, the printer driver 11 and the application 12 start up the HTML browser 13 (S81). Subsequently, the HTML browser 13 requests to acquire HTML information from the URL accessing the data sending/receiving unit 31 in the image forming apparatus Gk (S82) and acquires the HTML information (S83), and the printer driver 11 and the application 12 display the acquired HTML in which the preview image is embedded on the display (S14a)

As shown in FIG. 12, if a user browses the preview image and starts printing after modifying print settings if necessary (S15), the printer driver 11 and the application 12 generate print data and print setting data from the image data and the print settings (S16) and send the generated print data, print setting data, and the command to start printing to the data sending/receiving unit 31 in the image forming apparatus Gk via the network NW (S17).

In the image forming apparatus Gk, after transferring the print data, the print setting data, and the command to print from the information processing apparatus Js, the data sending/receiving unit 31 receives the print data, the print setting data, and the command to print, sends the print data, the print setting data, and the command to print to the print controller 41, and requests the print controller 41 to start generating a preview image (S28). Subsequently, the print controller 41 sends the print data and the print setting data to the data interpreter 43, and the data interpreter 43 interprets the data (S29).

After interpreting the data, the data interpreter 43 sends the interpretation result to the print controller 41 (S30). Subsequently, the print controller 41 sends the interpretation result, the print data, and the print setting data to the image drawing unit 34 (S31), and the image drawing unit 34 generates drawing data and preview image data that corresponds to the print settings and sends them to the print controller 41 (S32).

The print controller 41 sends the drawing data and the print setting data to the engine controller 36 and commands to print (S33). The engine controller 36 has the printer engine in the engine unit 24 form an image on paper based on the received drawing data and the print setting data (S34). The engine controller 36 sends the printing result by the engine unit 24 to the print controller 41, and the print controller 41 passes the printing result to the data sending/receiving unit 31 and has the data sending/receiving unit 31 send the printing result to the information processing apparatus Js (S35).

In the information processing apparatus Js, after receiving the printing result, the printer driver 11 and the application 12 display the printing result on the display.

As described above, in the image forming system 1 in this embodiment, after generating HTML in which a preview image is embedded and storing it in the data storage 23 in the image forming apparatus Gk, only the URL of the generated HTML is sent to the information processing apparatus Js. Subsequently, the preview image can be checked by accessing the URL of the HTML in which the preview image is embedded from the information processing apparatus Js. Accordingly, a preview image can be checked by using mobile communications devices, etc., even in the environment where upgrading drivers cannot be done easily, and that can enhance availability.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An image forming apparatus, comprising:
a communications unit to communicate data and commands with an information processing apparatus;
a drawing unit to generate drawing data from the image data received by the communications unit reflecting print setting data included in the image data;
an image forming unit to form and output an image on a recording medium based on the drawing data and the print setting data;
a preview image generating unit to generate preview image data from the image data reflecting the print setting data;
a preview image control unit to have the preview image generating unit generate the preview image data from the image data and send the generated preview image data to the information processing apparatus via the communications unit in case a preview command is included in the image data received by the communications unit; and
an image forming control unit to have the drawing unit generate drawing data based on the image data and the print setting data after the communications unit receives the image data, the print setting data, and a command to start printing and has the image forming unit form an image on a recording medium based on the generated image data.

2. The image forming apparatus according to claim 1, further comprising a storage unit to store the drawing data generated by the drawing unit and the print setting data, wherein the image forming control unit has the image forming unit form an image on a recording medium based on the drawing data specified by specifying data and the print setting data after the communications unit receives the specifying data that specifies the drawing data in the storage unit and a command to start printing, and the image forming control unit has the drawing unit generate drawing data newly based on drawing data specified by specifying data and the print setting data and has the image forming unit form an image on a recording medium based on the generated drawing data and the print setting data after the communications unit receives the specifying data, the print setting data, and a command to start printing.

3. The image forming apparatus according to claim 1, further comprising:
a print condition settings unit to input and set print settings; and
a print settings storing unit to store the input print settings,
wherein the drawing unit generates drawing data that reflects the print setting data and the print settings from the image data, and the preview image generating unit generates preview image data that reflects the print setting data and the print settings from the image data.

4. The image forming apparatus according to claim 3, wherein the print condition settings unit inputs the print settings corresponding to user information that specifies a user, the print settings storing unit stores the input print settings corresponding to the user information, the communications unit receives the user information from the information processing apparatus, the drawing unit generates drawing data that reflects the print setting data and the print settings that correspond to the user information, and the preview image generating unit generates preview image data that reflects the print setting data and the print settings that correspond to the user information.

5. The image forming apparatus according to claim 2, further comprising a start operating unit to input and set a command to start printing that specifies the drawing data in the storage unit and starts printing,
wherein the image forming control unit has the drawing unit generate drawing data based on the specified drawing data stored in the storage unit and the print setting data or the drawing data, the print setting data, and the print settings after the communications unit receives the specifying data that specifies the drawing data in the storage unit and a command to start printing and has the image forming unit form an image on a recording medium based on the generated drawing data.

6. An image forming system, comprising:
an information processing apparatus; and
the image forming apparatus according to claim 1,
wherein the information processing apparatus is connected with the image forming apparatus via a communications network, the information processing apparatus sends image data and a command to the image forming apparatus, and the image forming apparatus forms an image on a recording medium.

7. A method of controlling forming an image, comprising the steps of:
communicating data and commands with an information processing apparatus;
generating drawing data from the image data received in the data communicating step reflecting print setting data included in the image data;
forming and outputting an image on a recording medium based on the drawing data and the print setting data;
generating preview image data from the image data reflecting the print setting data;
generating the preview image data from the image data in the preview image generating step and sending the generated preview image data to the information processing apparatus in the communicating step in case a preview command is included in the image data received in the communicating step; and
generating drawing data based on the image data and the print setting data after receiving the image data, the print setting data, and a command to start printing in the communicating step and forming an image on a recording medium based on the generated image data in the image forming step.
